(19) United States
(12) Patent Application Publication
(10) Pub. No.: US 2011/0158138 A1
(43) Pub. Date: Jun. 30, 2011

(54) DATA TRANSFER METHOD AND APPARATUS

(75) Inventor: Rajanna Vivek, Bangalore (IN)

(73) Assignee: NOKIA CORPORATION, Espoo (FI)

(21) Appl. No.: 12/828,128

(22) Filed: Jun. 30, 2010

(30) Foreign Application Priority Data
Jun. 30, 2009 (GB) 0911342.4

(51) Int. Cl. H04L 12/56; H04W 40/00

(52) U.S. Cl. 370/310; 370/351

(57) ABSTRACT

One example of the invention provides a data source apparatus that in use provides data of one or more types to a sink device via a data transport communications link, the data source apparatus selecting the types of data to be provided to the sink device in dependence on the type of data transport communications link over which the data is to be provided. In one example the data to be provided is user data derived from one or more user applications. For example, one type of user data may be user contact data. Another type of user data is user task list data. A further example of user data is calendar data. A further example of user data is media data, for example video data, or audio data.

### CROSS REFERENCE TO RELATED APPLICATION

This application claims the priority benefit of Great Britain Application No. 0911342.4, filed Jun. 30, 2009, the contents of which are incorporated herein in their entirety.

### TECHNICAL FIELD

Embodiments of the present invention relate to a data transfer method and apparatus operating in accordance with the method.

### BACKGROUND TO EXAMPLES OF THE INVENTION

Data transfer protocols between source devices, such as digital cameras, mobile telephones, video camcorders, audio recorders, etc. and sink devices such as storage devices, computers, printers, display devices, are becoming more standardised, such as the Picture Transfer Protocol (PTP) and the more generic Media Transfer Protocol (MTP). Such data transfer protocols are physical, data and transport layer agnostic, and merely require that the lower layers provide reliable data communications.

### SUMMARY OF EXAMPLES OF THE INVENTION

One example of the invention provides a data source apparatus that in use provides data of one or more types to a sink device via a data transport communications link, the data source apparatus selecting the types of data to be provided to the sink device in dependence on the type of data transport communications link over which the data is to be provided. In one example the data to be provided is user data derived from one or more user applications. For example, one type of user data may be user contact data. Another type of user data is user task list data. A further example of user data is calendar data. A further example of user data is media data, for example video data, or audio data.

In one example the type of data transport link may be a wired type or a wireless type. Where the data transport link is a wired type then more types of data may be selected for transfer than if the data transport link is of a wireless type. Where the data transport link is of a wireless type, then different types of data may be selected for transfer depending on the type of wireless link employed. For example, for a wireless link of a first type, such as an IR or optical link, then more types of data may be selected for transfer than when using a wireless link of a second type, such as an RF link. For example, the RF link may be a BlueTooth® link.

In one example the user data is categorised into classes, and a class of data of different types assigned to the different types of data transport to be used to transport the data between the source and the sink. Thus, there may be a wired class defining the types of data that would be transferred over a wired bearer, and one or more wireless classes defining the types of data that would be transferred over different types of wireless links. For example, a directed wireless link, such as an IR or optical link, may have a class containing more types of data than a non-directed wireless link, such as an RF link.

In one example, personal user data is not sent where the transport link is potentially interceptible, such as is the case with a wireless link. However, for some types of wireless link, such as directed wireless links such as a IR or optical links, then some types of personal user data may be sent. Individual policies may be set to determine which data is sent under which circumstances.

In view of the above, one example of the invention provides a method, comprising: a) determining a type of data channel to be used in a data transfer process from a source device to a sink device; b) selecting one or more types of data from a plurality of available data types to be transferred during the data transfer process, the selection being made in dependence on the determined type of data channel; and c) during the data transfer process, providing data or information about the data of the selected type(s) from the source device to the sink device.

In one example available types of data channel to be used in the data transfer process include wired and wireless type channels.

In one example the selecting selects more types of data to be transferred in the event that the determining determines that the type of data channel is a wired data channel than if the determining determines that the type of channel is a wireless channel.

In another example types of data corresponding to personal user data are not selected for transfer in the event that the determined data channel type is a wireless type. Personal user data includes one or more selected from the group comprising: contact data; calendar data; task list data; diary data.

In a further example types of data having files of characteristically large sizes are not selected for transfer in the event that the determined data channel type is a wireless type. The types of data having large files include one or more selected from the group comprising: audio data, video data, and picture data.

In a further example the data transfer process is a request-response process, wherein a request for data is received from a data transfer initiator in the sink device, and a response comprising data or information about data is sent in reply from a data transfer responder in the source device. In a more specific related example the data transfer process is performed in accordance with the Media Transfer Protocol.

In a further example the data transfer process is part of a synchronisation process to synchronise data stored in the source device and sink device.

In a yet further example the source device is any device selected from the group comprising: a smartphone, a digital camera or camcorder, a media recorder, a computer, a data storage device. In the example the sink device may be any device selected from the group comprising: a computer (laptop, desktop, notebook, netbook, or otherwise), a portable HDD, portable solid state memory, or any other data storage device

In another example the invention provides a computer program or suite of computer programs so arranged such that when executed on a computer it/they cause the computer to operate in accordance with the method of any of the preceding examples. Furthermore, a further example provides a computer readable storage medium storing a computer program or at least one of the suite of computer programs according to the previous example.

From another aspect, another example of the invention provides an apparatus, comprising: a data transfer framework including a data transfer responder, the data transfer framework facilitating a data transfer process for transferring data to a sink device; a data transport controller providing at least one data channel over which data is data is transferred during the data transfer process, and one or more data generating modules that generate data of different types; wherein the data transfer responder determines, for a particular data transfer to be made, the type of data channel to be used in the data transfer process, and selects, in dependence on the determined type of data channel one or more types of data of the different types to be transferred in a subsequent data transfer process; wherein data or information about the data of the selected types are provide during a subsequent data transfer process to the sink device.

An example according to a further aspect of the invention also provides an apparatus, comprising: at least one processor; and at least one memory including computer program code; the at least one memory and the computer program code configured to, with the at least one processor, cause the apparatus to perform at least the following: a) determine a type of data channel to be used in a data transfer process to a sink device; b) select one or more types of data from a plurality of available data types to be transferred during the data transfer process, the selection being made in dependence on the determined type of data channel; and c) during the data transfer process, provide data or information about the data of the selected type(s) to the sink device.

Moreover, another example of the invention provides a source device that provides data to a sink device during a data transfer process, the source device comprising: a) means for determining a type of data channel to be used in a data transfer process from the source device to the sink device; b) selection means for selecting one or more types of data from a plurality of available data types available to be transferred during the data transfer process, the selection being made in dependence on the determined type of data channel; and c) data transfer means that, during the data transfer process, provide data or information about the data of the selected data type(s) from the source device to the sink device.

### BRIEF DESCRIPTION OF THE DRAWINGS

Further features and advantages of examples of the invention will become apparent from the following description of specific embodiments of the invention, presented by way of example only, and by reference to the accompanying drawings, wherein like reference numerals refer to like parts, and wherein:

FIG. 1 is a block diagram showing a data source device of a first example of the invention and a data sink device;

FIG. 2 is a flow diagram illustrating the operation of the data source device of the first example;

FIG. 3 is a diagram illustrating the operation of the data source device of the first example.

FIG. 4 is a diagram illustrating the operation of the data source device of the first example;

FIG. 5 is a block diagram of a mobile telephone forming a data source device of a second example of the invention;

FIG. 6 is a flow diagram illustrating the operation of the mobile telephone of the second example; and

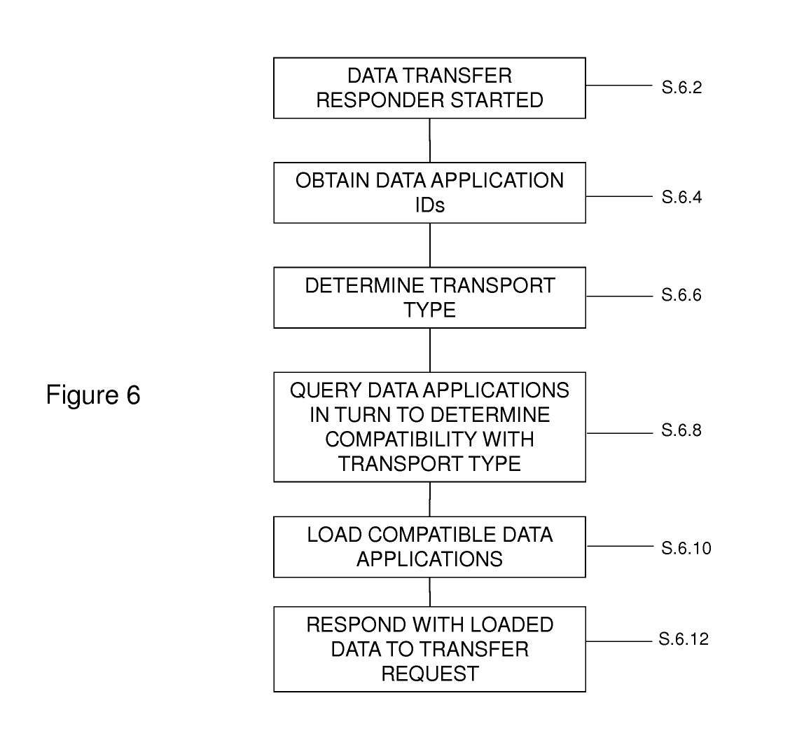

FIG. 7 is a diagram illustrating the operation of the second example of the invention.

### DESCRIPTION OF SPECIFIC EMBODIMENTS

Various examples of the invention will now be described with respect to the accompanying figures.

It is increasingly more common that data of various different types must be transferred from one device to another device. For example, with the advent of digital cameras and camcorders, it is often the case that picture or video data must be transferred from a digital camera device onto another device for storage or processing, such as a laptop or desktop computer. Sometimes, digital cameras can be connected direct to “direct-to-print” printers, for printing digital images without using a computer. Similarly, portable media players are prevalent, wherein media data such as MP3 files, or coded video files such as DivX, XVid, MP4, H.264 AVC files, or the like are transferred. Similarly, cellular phones are often a source of data that needs to be transferred onto other devices, such as, for example, picture data that may have been captured with a cellular phone camera, video data, recorded audio data, as well as personal user data, such as contact data, task list data, diary data, calendar data, emails, and text messages. Several proprietary data transport protocols for transferring data in a reliable manner between such source and sink devices are available, but such protocols are increasingly becoming standardised, and particularly through the use of the Media Transfer Protocol (MTP). The Media Transfer Protocol is a protocol designed for content exchange with and command and control of transient storage devices. It has been developed as an extension to PTP, or Picture Transfer Protocol, and is targeted primarily at digital still cameras, portable media players, and cellular phones.

The primary purpose of a data transfer protocol such as MTP is to facilitate communication between media devices that have transient connectivity and significant storage capacity. This includes the exchange of binary objects and the enumeration of the contents of that connected device. The secondary purpose of such protocols is often to enable command and control of the connected device. This includes the remote invocation of device functionality, monitoring device-initiated events, and the reading and setting of device properties. In a data transfer protocol such as MTP, devices generally act primarily as either media consumers or media producers, although this line is becoming increasingly blurred, and a single device can act as both a media producer (data source or generator) or media consumer (data sink).

A data transfer protocol such as MTP typically follows a simple operation-data-response model for all communications. Exchanges usually only occur between two products at a time, and in each communication one product acts as the initiator, and the other as the responder. The initiator is the product that initiates actions with the responder by sending operations to the responder. The responder may not initiate any actions, and may only send responses to operations sent by the initiator, or send events. Often, where, for example, USB is being used as the data transport providing the data channel between the devices, the USB host on the sink device would be the initiator, and the USB device is the responder.

Irrespective of the type of data transport used, generally the initiator must be able to enumerate and understand the contents of the responder, handle and respond to events generated by the responder, and control the flow of the operations in the protocol. Products expected to take on the responder role include content production devices, such as digital cameras, or portable audio recorders, and content display devices, such as personal information managers, and portable audio and video players. Typical products that take on the initiator role include personal computers, and products such as direct print printers. Cellular phones may take either role, as modern smartphones are capable for use in generating content, for example capturing digital still images, video, or sound, as well as displaying existing content, whether audio or video.

In data transfer protocols such as MTP the data flow is unidirectional. When initiating an operation, data flows only from the initiator to the responder. When responding to the requested operation, the data flows only from the responder to the initiator. During the binary data exchange phase, data may flow from the responder to the initiator, or from the initiator to the responder. Bidirectional, binary data exchange is usually performed by multiple request-response operations.

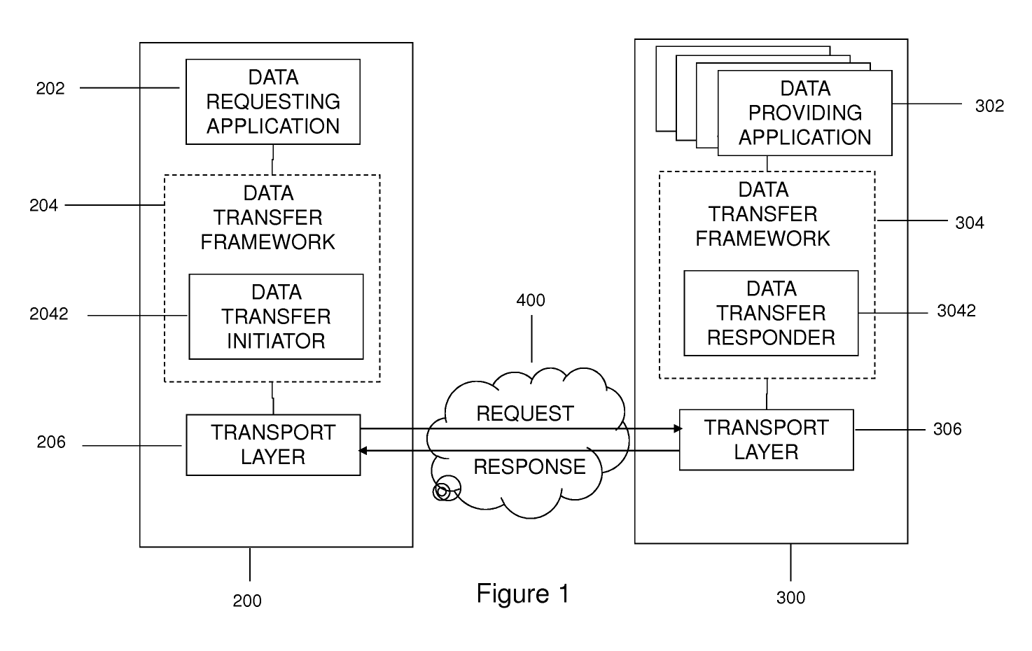

An example of the invention will now be described with respect to FIGS. 1 to 4. FIG. 1 illustrates a typical source device 300, and a sink device 200. The source device 300 may be, for example, a cellular phone, a digital camera or camcorder, or any such content production device, or a device with other data, such as personal user data or other files, to be transferred. A sink device 200 is provided, that will typically take the initiator role. The sink device 200 is a device on which data to be transferred is to be stored, or processed, or otherwise coordinated. For example, the sink device 200 may be a laptop computer, a desktop computer, or the like. In other examples the sink device may be a mass storage device such as a portable HDD, provided it has host capabilities. That is, the sink device need not have significant processing capabilities, and could be intended for use simply for data storage.

What ever the precise form and intended use of the sink device, in this example the sink device 200 has running on it a data requesting application 202. Also provided is a data transfer framework 204, which operates in accordance with a data transfer protocol, such as MTP, PTP, or some other proprietary data transfer protocol. As part of the data transfer framework, a data transfer initiator 2042 is brought into being, to handle the initiator end of the data transfer protocol, in order to transfer data from the source device 300 to the sink device 200. The data transfer framework 204 is agnostic to the particular data transport mechanism that is used, and any data transport mechanism may be used, such as USB, or also wireless data transport mechanisms, such as Bluetooth®, infrared (usually in accordance with the IrDA family of specifications), optical, and the like. A transport layer controller 206 in the sink device represents functionality of the actual data bearer channel.

Corresponding elements are present in the source device 300. In particular, the source device 300 may contain one or more data providing applications 302, which are the actual data generation applications that generate the data to be transferred. For example, one data providing application may be a diary application, which generates diary data. Another data providing application may be a task list application, which contains task list data. A further data providing application may be a contacts application, that stores user contact data. The user contact data may include any of telephone numbers, residential addresses, email addresses, URLs, mobile telephone numbers, home telephone numbers, as well as other contact meta-data relating to a contact. Another example data providing application is a media recorder, for example recording video images, or still digital images. The media recorder alternatively or additionally may record audio data.

Additionally provided in the source device 300 is a corresponding data transfer framework 304 to the data transfer framework 204 in the sink device 200. The data transfer framework 304 in the source device causes the device to operate in accordance with the data transfer protocol that is being used, for example MTP, or PTP. As part of the data transfer framework 304 a data transfer responder 3042 is created, to specifically control any response to requests from the data transfer initiator 2042 in the sink device, and to transfer data to the sink device. Additionally within the source device is a transport layer controller 306, which controls the actual data bearer over which the data is to be sent. For example, the transport layer controller may be a USB controller, such that the data bearer 400 is a USB channel, typically over a wire. Alternatively, other types of data bearer may be used, such as wireless data bearers e.g. Bluetooth®, infrared (IrDA), optical, or the like. Of course, the same data transport mechanism should be used between the source device 300 and the sink device 200, in order for data to be successfully transferred.

The present example of the invention addresses the problem that the user may not wish some types of data to be transferred from the source device 300 to the sink device 200 by the data transfer protocol if that data could be intercepted by eavesdropping third parties. Thus, where there is the possibility of the data bearer being intercepted, such as is the case with a wireless bearer, the user may not wish certain types of data, such as personal user data, to be sent using the data transfer protocol. However, where the data bearer is more secure, such as when using a wired USB bearer, the user may be happy for all types of data, or a greater number of types of data, to be transferred.

The table below gives an example of all sorts of data that the user may allow to be transferred using the data transfer protocol, depending on bearer type.

| Data Bearer Type: | Types of Data: |
|---|---|
| Wired USB | diary data, audio data, task list data, |
| | contact data, calendar data, emails, text |
| | messages, word processing documents, |
| | spread sheets, presentation documents, |
| | audio data, video data |
| Wireless Infrared or optical | diary data, audio data, calendar data, |
| | emails, text messages, word processing |
| | documents, spread sheets, presentation |
| | documents |
| Wireless Bluetooth | audio data, emails, text messages, word |
| | processing documents, spread sheets, |
| | presentation documents, audio data |

Thus, as will be seen from the table above, in an example of the invention a user is able to specify, for particular data bearer types, what types of data are then transferred using the data transfer protocol. This allows some types of data to be kept secure in the source device, in the case that there is the potential for the bearer to be intercepted.

A table such as the above, which in the example is configurable by the user so that the user can add different data types against different bearers, and take away data types from different bearers, is stored by the data transfer framework 304, and used by the data transfer responder 3042 to determine whether different data types should be sent. Alternatively, each data providing application 302 can, in another example, be configured to specify whether its particular data type can be sent via a particular bearer type. Thus, for example, a calendar application may contain settings specifying whether calendar data produced by the calendar application should be sent by various different data types. These settings can be stored within the applications themselves, or, in another example, as meta-data attached to the actual data produced by a particular application. Thus, for example, a calendar application which produces calendar data, would attach to that data meta-data indicating the particular data bearer types over which it can be transferred.

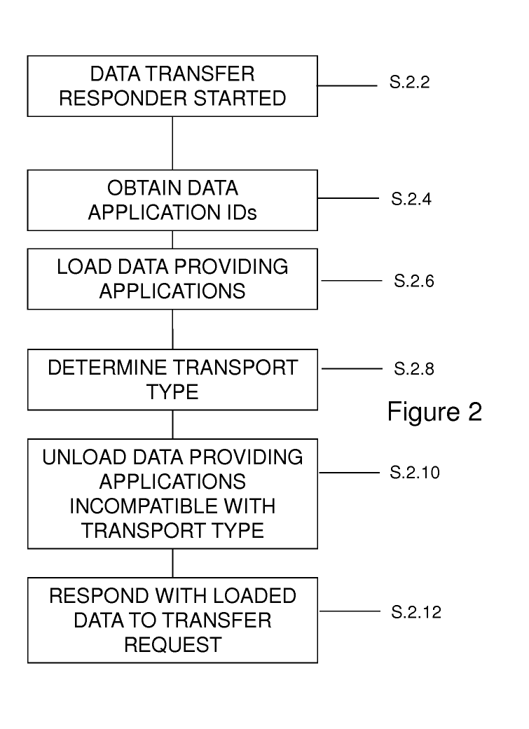

FIG. 2 illustrates the processing performed in an example of the invention, having the apparatus of the source device of FIG. 1. In particular, at step 2.2 it is determined that a data transfer is to take place, and the data transfer responder 3042 in the data transfer framework 304 within the source device 300 has started. At step 2.4 the data transfer responder 3042 contacts the operating system, to obtain the application IDs of data-providing applications on the system, such as, for example, a file data providing application, a contact data providing application, a task list data providing application, a word processing application, a media recorder, and the like. At step 2.6 the various data providing applications the IDs of which are obtained from the operating system are then loaded, and at step 2.8 the data transfer responder 3042 contacts the transport layer 306 to determine the type of data bearer that is to be used for the data transfer. The transport layer returns with the data bearer type e.g. USB wired, wireless IR, wireless-Bluetooth, etc. and then at step 2.10 the data transfer responder 3042 determines one application at a time whether the data generated by the respective data applications are suitable to be sent over the data bearer type returned from the transport layer controller 306. Any data providing applications that are not compatible with the data bearer type are then unloaded.

Thereafter, the data transfer responder 3042 is in a position to respond to requests from the data transfer initiator 2042 in the sink machine 200. As was explained earlier, in any typical data transfer protocol such as MTP or PTP data is transferred using a request-response model.

At step 2.12 when a data transfer request or a device information request (such as, in MTP, a GetDeviceInfo( ) request) is received, the data transfer responder 3042 reports back to the data transfer initiator 2042 with information regarding the types of data and the associated data-providing applications for those types of data that have been selected to be transferred over the data bearer type. Such operation has two principle advantages. The first is that it provides the user with better control over data, with respect to the security of the data link over which data is to be transferred. In particular the user can decide whether data of different types is going to be transferred, and hence can prevent sensitive data such as user personal data from being transferred over bearers where the data might be intercepted.

The second advantage relates to the available bandwidth of links of different types. A wireless link may have a lower data rate than a wired link, and hence, as well as taking into account security concerns, the user may decide that certain large files, such as video files, for example, should only be transferred using higher bandwidth links such as a USB wired link. This would help to control transfer time from the resource device to the sink device during data synchronisation processes.

In another example, therefore, the user selects the data file types to be transferred dependent on each bearer type not just taking into account security of the bearers, but also taking into account data transfer time, which is dependent on bearer bandwidth. Depending on the users preferences, it may be that in fact data transfer time is more important to the user than data security. In such a case the user may configure the arrangement such that for a USB wired link all data types may be sent, but for a wireless link or other link of lower bandwidth, only those data types which do not produce large files are sent. Thus, for example, contact data, calendar data, task list data, and diary may be sent using the wireless links, but conversely video data and audio data may not.

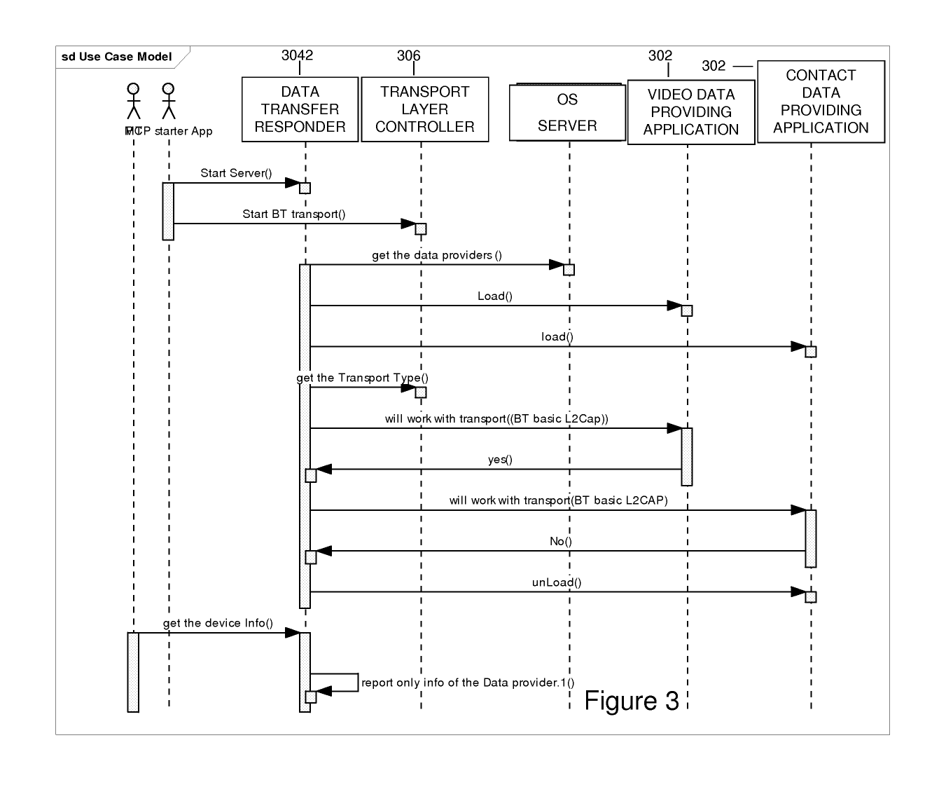

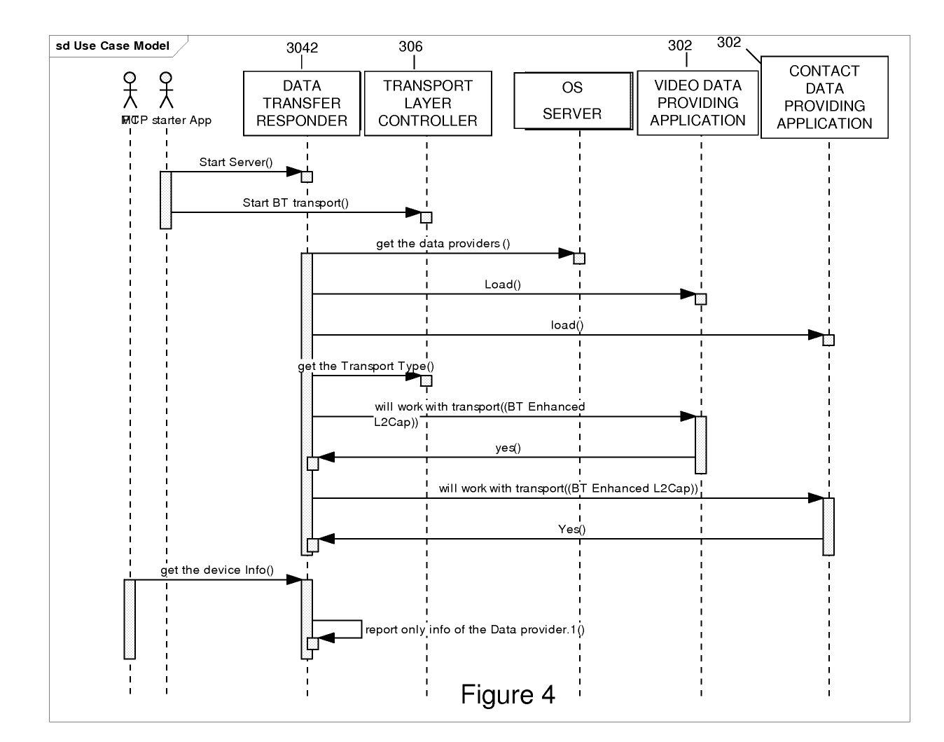

FIGS. 3 and 4 illustrate the above described operation in more detail for a specific example. Here, the data transport is provided by Bluetooth, and a video data providing application 302 and contact data providing application 302 are used as examples.

In the example of FIG. 3, where it is determined by some starter application that a data transfer is to take place, the starter application starts the data transfer responder 3042 in the data transfer framework, and the transport layer controller 306. The starter application may, for example, be a background programme that runs all the time, for example monitoring whether the source device is placed into a base station or cradle, for example to synchronise with a laptop or desk top computer. Alternatively, it may be part of the OS or user interface, providing a user control to command a device to perform a data transfer.

Howsoever the data transfer is started, once the data transfer responder 3042 and the data transfer framework are up and running, it contacts an appropriate server in the OS to obtain application IDs of data providing applications 302. In this example, the OS server returns the application IDs of a video data providing application, and a contact data providing application. The data transfer responder 3042 then causes these applications to load, such that they can provide data, if necessary.

Next, the data transfer responder 3042 contacts the transport layer controller 306, and obtains the bearer type (i.e. the data bearer type). In this case, the bearer type is Bluetooth. Having obtained the bearer type, the data transfer responder then queries each individual data-providing application that is running, to determine whether that application is willing to provides its data via the bearer type. Here, there are two different cases shown in FIGS. 3 and 4. In FIG. 3, when queried the video data providing application responds positively, and hence is left running. Conversely, the contact data providing application responds negatively, and hence is unloaded. Thus, when a device query is received from the data transfer initiator in the sink device, the data transfer responder 3042 reports only information relating to the data providing application that it is still running, i.e. in this case the video data providing application.

Conversely, FIG. 4 shows the case where both the video data providing application and the contact data providing application return positive. In that case, when a GetDeviceInfo( ) type query is received from the data transfer initiator in the sink device, the data transfer responder can report with information relating to data from both of the data providing applications.

In the above example we have used the examples of a video data providing application, and a contact data providing application. Of course, in other examples many different types of data providing applications may be queried, depending on the various different types of data and applications available on the source device. Various different types of data and data providing applications were discussed previously.

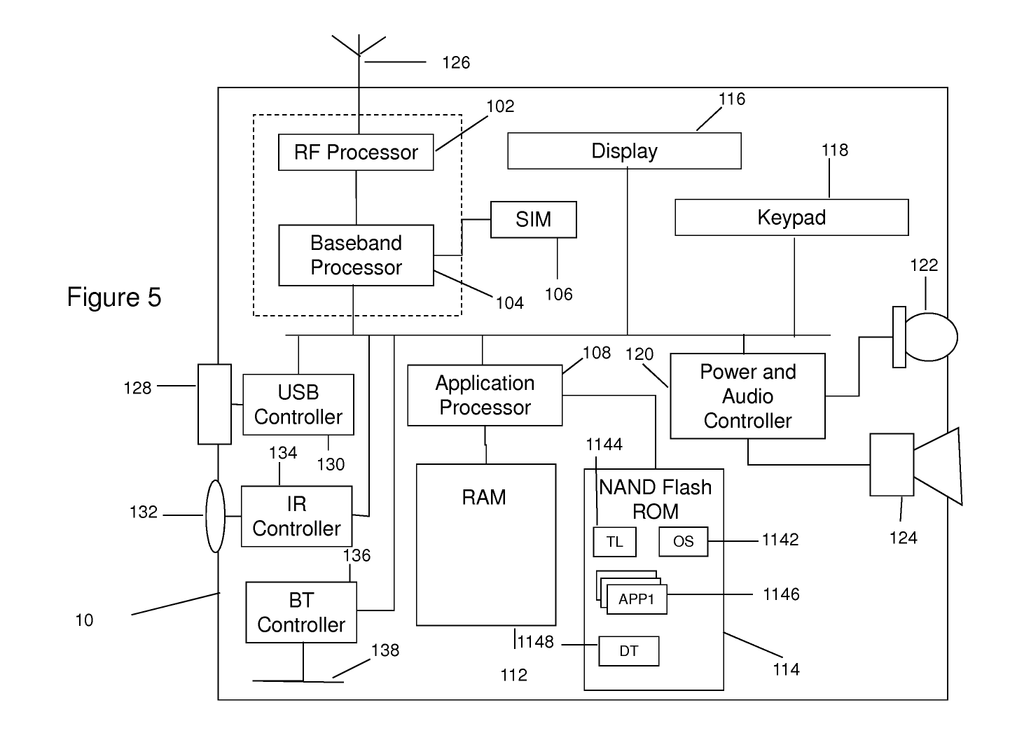

Another example of the invention will now be described with respect to FIG. 5. In this example the source device is a smartphone 10 comprising hardware to perform telephony functions, together with an application processor in corresponding support hardware to enable the phone to have other functions which are desired by a smartphone, such as messaging, calendar, contacts, word processing functions, and the like. In FIG. 5 the telephony hardware is represented by the RF processor 102 which provides an RF signal to antenna 126 for the transmission of telephony signals, and the receipt therefrom. Additionally provided is baseband processor 104, which provides signals to and receives signals from the RF processor 102. The baseband processor 104 also interacts with a subscriber identity module 106, as is well known in the art.

Also provided in this example is a display 116, and a keypad 118. These are controlled by an application processor 108, which is often a separate integrated circuit from the baseband processor 104 and RF processor 102, although in the future it is anticipated that single chip solutions will become available. A power and audio controller 120 is provided to supply power from a battery (not shown) to the telephony subsystem, the application processor, and the other hardware. Additionally, the power and audio controller 120 also controls input from a microphone 122, and audio output via a speaker 124.

The smartphone 10 also has several different data interfaces, which provide for data transfer into and out of the phone. In particular, a USB port 128, with an associated USB controller 130 is provided, to provide for wired data transfer in and out of the smartphone 10 in accordance with the provisions of the various USB standards. In addition, for short-range optical data transfer an IR port 132 and associated IR controller 134 are also provided, as well as a Bluetooth® (BT) controller 136 and antenna 138 for short-range RF data transfers. The IR port 132 and controller 134 and Bluetooth module 136 provide different types of wireless communications for data transfer in and out of the phone.

In order for the application processor 108 to operate, various different types of memory are often provided. Firstly, the application processor 108 may be provided with some random access memory (RAM) 112, into which data and program code can be written and read from at will. Code placed anywhere in RAM can be executed by the application processor 108 from the RAM.

Additionally provided is separate user memory 110, which is used to store user data, such as user application programs (typically higher layer application programs which determine the functionality of the device), as well as user data files, and the like.

In order for the application processor 108 to operate, an operating system 1142 is provided, which is started as soon as the smartphone system 10 is first switched on. The operating system code 1142 is commonly stored in a read only memory, as shown, and in modern devices the read only memory is often NAND flash ROM 114. The ROM will store the necessary operating system components in order for the device 10 to operate, but other software programs might also be stored, such as application programs, and the like, and in particular those application programs which are mandatory to the device, such as, in the case of a smartphone, communications applications and the like. In addition, as shown in FIG. 5, the smartphone 10 in the present embodiment also stores various programs which when loaded into RAM and run (or when run from ROM, if the ROM is execute-in-place (XIP)) form the actors of the present example. In particular, transport layer control software 1144 is stored, as well the various data providing applications 1146. As discussed with respect to previous examples, the data providing applications may be, for example, any one or more of a contacts manager application, a diary manager application, a task list application, a calendar application, a word processing application, a camera application, a video recorder application, a sound recorder application, a spreadsheet application, a presentations application, an email manager application, or any other type of application that produces data.

Also stored is the data transfer framework software 1148, which includes the code for a data transfer responder and data transfer initiator. The data transfer framework allows the smartphone 10 to transfer data according to a data transfer protocol, such as MTP or PTP.

In the present example, imagine that the user of the smartphone 10 has data stored on the smartphone, which he wishes to transfer to a sink device, such as, for example, a desktop computer. For example, the user may wish to synchronise contacts and diary data between the smartphone and the desktop computer. In addition, the user may also have taken photographs, or recorded video using the smartphone, which he also wishes to transfer to the desktop computer. In order to do this, the user initiates a synchronisation process, for example by connecting the smartphone 10 to the desktop computer using a USB lead. In this case, the data bearer will be wired USB. Alternatively, if the desktop computer is capable, it may be provided with an IR port or Bluetooth functionality, in which case the user may select either IR or Bluetooth transfer. As discussed previously, the smartphone 10 is preferably provided with a lightweight starter application which allows the user to indicate that a data transfer is to be performed, and to select a bearer type for the data transfer. Alternatively, where the user simply plugs a USB cable into the USB port 128 to connect the smartphone 10 to the desktop computer via USB, then no explicit selection of data transfer may be required, and the starter application will start the data transfer framework automatically.

Howsoever the data transfer framework is started, at step 6.2 the data transfer responder as part of the data transfer framework is also started. As part of the first actions performed by the data transfer responder, before it responds to any requests from a data transfer initiator in the desktop computer, the data transfer responder obtains data application IDs of data providing applications from the operating system 1142. This is performed at step 6.4.

Next, at step 6.6 the data transfer responder running in the smartphone contacts the transport layer controller, to determine which data transport bearer the user has selected for the data transfer. The transport layer controller returns the transport layer type, and the data transfer responder then passes the data transport type to each potential data providing application in turn, and receives a response from the data providing application as to whether that data providing application is compatible with the data transport type.

In an alternative example, instead of querying each data providing application in turn, the data transfer responder can use a look up table which specifies, for each data bearer type, which data providing applications are compatible.

Once the data transfer responder has determined which data providing applications are compatible with the data transport type, those data providing applications are loaded, and then the data transfer responder is ready to respond to any data transfer request with appropriate information. For example, if a GetDeviceInfo request is received from a data transfer initiator in the desktop computer, the data transfer responder will then respond with information relating to the types of data and data providing applications that are compatible with the selected data bearer, at step 6.12.

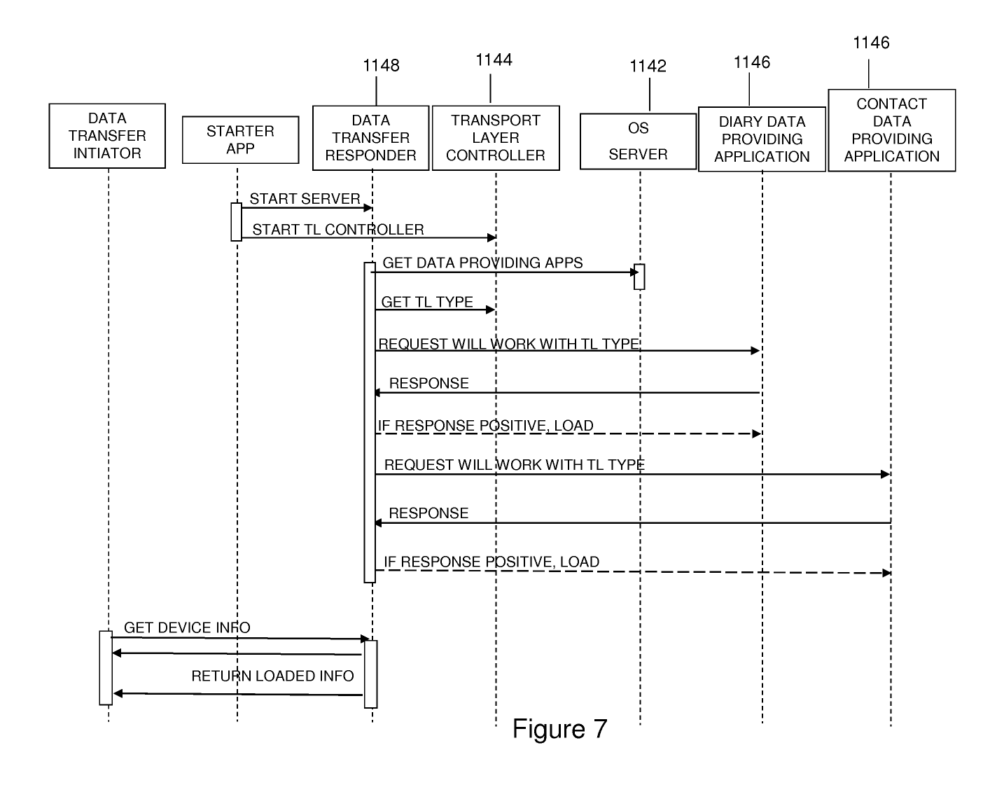

This operation is shown in more detail in FIG. 7. In particular, here, as shown, the data transfer responder obtains the information about the data providing applications from the OS server 1142, and about the data transfer bearer type from the transport layer controller 1144. Then, the data transfer responder contacts each data providing application in turn to determine whether that application is allowed to transfer data of its type over the data bearer type to be used for the data transfer, and if a positive response is received, the data providing application is caused to load in order to be able to transfer data. Alternatively, if a data providing application specifies that it is not able to transfer data over the selected data bearer, then it is not loaded. After the end of this period, the source device is then in a position to respond to transfer requests from the data transfer initiator in the desktop computer with data of the appropriate types for the data transport bearer to be used.

Various modifications may be made to the above described examples to provide further examples.

In the above examples the data transfer responder 1148 contacts each data-providing application to determine whether it will work with the transport layer type. However, in another example, as mentioned, instead of doing this, the data transfer responder can maintain a look up table with a list of data providing applications for each data bearer type. This would do away with the need to contact each application in turn. However, contacting each application in turn does allow each application to keep control of which bearer types its data is to be transferred over. For example, if a particular application is updated, such that it then produces different data types, for example two or more data types, which may be new data types, then by keeping a record in the application as to which data transport bearer types are allowed to transport each type of data produced by the application a more accurate and up to date record can be maintained. Where a central look up table is used in the data transfer responder, then that look up table may not be updated when a data providing application is updated, and hence there is the possibility for error.

In one example of the invention the selection of which data types produced by which data-providing applications are to be sent over which bearers can be left completely to the user. However, in other examples, there may be preset classes of data types that are associated with each different data bearer type. Thus, for example, a class of data types may be associated with the USB data bearer, the class containing those types of data that should be transferred via USB. Typically, for USB transfer, any type of data can be transferred. For other data transfer types, such as IR, or Bluetooth, only some classes of data may be transferred. For example, personal user data, such as contact data, task list data, diary data, and calendar data, may not be transferred over wireless links such as IR or Bluetooth. This is to increase security of the personal user data. In another example, data with high volumes, such as video data, or picture data, will also not be transferred over wireless links such as IR, or Bluetooth.

In other examples, it may be that a subset of personal user data can be transferred over wireless links. The subset may include some types of personal user data, but not other types. For example, calendar data, diary data, and task list data may be transferred, but contact data is kept more secure.

Similarly, in other examples a data size threshold may be set specifying what files of which sizes may be sent over different bearer types. In this way, the user can control synchronisation times. For example, it may be that the user is not concerned about security at all, such that all data types can be sent over any type of data bearer. However, in this case the user may be more concerned with data transfer times, in that he does not want to transfer large files that will take a long time to transfer. In this case, the user may set a file threshold limit for each data bearer type, such that files over that limit are not reported to the data transfer initiator by the data transfer responder as being available for data transfer. This provides a middle ground in that discrimination is not made solely on the type of the data, but upon another parameter of an individual data file, in this case its size.

In other examples, other parameters of data files may be used as discriminators in dependence on bearer type. For example, the date at which the file was created may act as a discriminator. For example, only files created after or before a certain data may be made available for data transfer.

In further examples two or more file characteristics may be combined together to discriminate as to which data files can be made available for transfer. For example, both size and date of file may be used as a discriminator, e.g. files below a certain size created after a certain date are made available for transfer, but files that do not meet both these criteria are not.

Examples of the invention therefore allow a user to specify which types of data should be transferred from a source device to a sink device in dependence on the data bearer type between the two devices. The discrimination between types of data includes what sort of data is actually being passed which in turn depends on the data-providing application that generated the data, as well as characteristics of the data, such as its size, or the date it was created, or last modified. In this way, the user can help to both maintain the security of his data during data transfer requests, and, also, in some examples, help control data transfer times to within his or her preferences.

Various further modifications, whether by way of addition, deletion, or substitution will be apparent to the intended reader, being a person skilled in the art, to provide further examples, any and all of which are intended to fall within the appended claims.

What is claimed is:

1. A method comprising:
determining a type of data channel to be used in a data transfer process from a source device to a sink device;
selecting at least one data type from a plurality of available data types to be transferred during the data transfer process, the selection being made in dependence on the determined type of data channel; and
during the data transfer process, providing information about the selected data type from the source device to the sink device.

2. A method according to claim 1, wherein the available data channel types to be used in the data transfer process includes at least one of wired and wireless data channels.

3. A method according to claims 2, wherein more data types are selected to be transferred if the determined type of data channel is the wired data channel than if the determined type of channel is the wireless data channel.

4. A method according to claim 1, wherein data types corresponding to personal user data are not selected for transfer if the determined data channel type is the wireless data channel.

5. A method according to claim 4, wherein personal user data is selected from the group comprising: contact data, calendar data, task list data, and diary data.

6. A method according to claim 1, wherein data types having files of characteristically large sizes are not selected for transfer if the determined data channel type is the wireless data type.

7. A method according to claim 6, wherein the data types having large files is selected from the group comprising: audio data, video data, and picture data.

8. A method according to claim 1, wherein the data transfer process is a request-response process, wherein a request for data is received from a data transfer initiator in the sink device, and a response comprising information about the data is sent in reply from a data transfer responder in the source device.

9. A method according to claim 8, wherein the data transfer process is performed in accordance with a media transfer protocol.

10. A method according to claim 1, wherein the data transfer process is part of a synchronisation process to synchronise data stored in the source device and the sink device.

11. A computer program product comprising computer program code which when executed on an apparatus cause the apparatus to perform at least:
determine type of data channel to be used in a data transfer process from a source device to a sink device;
select at least one data type from a plurality of available data types to be transferred during the data transfer process, the selection being made in dependence on the determined type of data channel; and
during the data transfer process, provide information about the selected data type from the source device to the sink device.

12. An apparatus comprising:
a data transfer framework comprising a data transfer responder, the data transfer framework facilitating a data transfer process for transferring data to a sink device;
a data transport controller providing at least one data channel over which data is transferred during the data transfer process; and
one or more data generating modules that generate data of different types;
wherein the data transfer responder determines, for a particular data transfer to be made, a data channel type to be used in the data transfer process, and selects, in dependence on the determined data channel type, at least one data type of the different types to be transferred in a data transfer process; and
wherein information about the data type selected is provided during the data transfer process to the sink device.

13. An apparatus comprising:
at least one processor; and
at least one memory including computer program code the at least one memory and the computer program code configured to, with the at least one processor, cause the apparatus to perform at least the following:
determine a type of data channel to be used in a data transfer process to a sink device;
select at least one data type from a plurality of available data types to be transferred during the data transfer process, the selection being made in dependence on the determined type of data channel; and
during the data transfer process, provide information about the selected data type to the sink device.
